(19) United States
(12) Patent Application Publication
(10) Pub. No.: US 2011/0116574 A1
(43) Pub. Date: May 19, 2011

(54) Trellis coded modulation with periodically-reduced signal constellations

(76) Inventors: Eric Morgan Dowling, San Jose (CR); John P. Fonseka, Plano, TX (US)

(21) Appl. No.: 12/591,273

(22) Filed: Nov. 16, 2009

(51) Int. Cl. H04L 27/36

(52) U.S. Cl. 375/298

(57) ABSTRACT

An family of improved trellis coded signaling schemes is provided that by vary the signal constellation to a smaller constellation periodically according to a pre-selected pattern. A set of specific embodiments involving periodically-reduced 4-PAM/2-PAM trellis coded schemes are disclosed that change their signal constellations periodically from 4-PAM to 2-PAM during selected intervals to improve performance. Similar periodically QAM and higher-dimensional coding schemes are also disclosed. Simplified receiver and decoder structures to decode the periodically-reduced trellis codes are also presented. The present invention allows embodiments to be produced that reduce coding complexity, reduce decoding complexity, and simplify symbol timing recovery and equalization. The cost is a moderate increase in the path memory length of the decoder.

### BACKGROUND OF THE INVENTION

1. Field of the Invention

This invention relates generally to communication transmitters, receivers, and systems. More particularly, the invention relates a trellis coded signaling schemes that vary their signal constellation to a smaller constellation periodically according to a pre-selected pattern.

2. Description of the Related Art

The use of trellis codes and TCM (trellis coded modulation) in modern communication systems is well known. Trellis codes offer significant coding gains without expanding the bandwidth. Trellis codes are constructed by passing the message sequence U through a rate n/(n+1) convolutional code followed by a mapper that maps the coded bits V on to a constellation point. Many different types of signal constellations are known, including one-dimensional constellations associated with PAM (pulse amplitude modulation) and two-dimensional constellations associated with QAM (quadrature amplitude modulation) or various types of PSK (phase shift keying). Also, multi-dimensional constellations made up of more than two dimensions are known.

FIG. 1 shows a TCM encoder/mapper that uses a v=2, (5,2) rate-Y2 convolutional code and a 4-PAM signal mapper to create a known trellis-coded 4-PAM communication signal. This prior art TCM encoder/mapper maps each uncoded bit onto coded bits V₁ and V₂, and then maps the coded bits onto a 4-PAM signal constellation point according to the mapping rule; {00, 01, 10, 11}→{+3a, +a, −a, −3a} during all signaling intervals. The encoded 4-PAM output of the TCM encoder/mapper of FIG. 1 has a raw minimum Euclidean distance of Dₘᵢₙ²=36a², and it uses an average symbol energy of 5a². Hence, the normalized minimum distance of the trellis coded scheme in FIG. 1 is dₘᵢₙ²=3.6, and it gains 2.55 dB over uncoded 2-PAM. Further, it is known that the path memory length of the decoder used to decode the coded 4-PAM signal generated by FIG. 1 is, N_{R}=10. The path memory length is the minimum number of intervals that any two paths in a Viterbi decoder have to travel to gain a distance of at least the minimum distance.

Prior art trellis coded schemes use one selected constellation and employ the same constellation throughout the transmission. Some multidimensional trellis coded modulation schemes are known where the sub-portions of the signal constellation change between sub-intervals (e.g. between constituent 2D QAM intervals) within the multidimensional symbol interval (e.g., 4D or 8D multidimensional Wei code as discussed in U.S. Pat. No. 4,713,817, which is hereby incorporated herein by reference). However, the constellation defined at the multidimensional symbol level is the same from one multi-dimensional symbol interval to the next.

It would be desirable to have a trellis coded modulation strategy that could improve upon known trellis coded modulation strategies by changing the constellation used for transmission periodically from one symbol interval to the next. It would be desirable to periodically combine selected groups of constellation points into respective single constellation points during selected periodic signaling intervals. This would allow TCM systems to be designed that have increased coding gain, reduced coding complexity, and simpler symbol timing recovery and equalization subsystems.

### SUMMARY OF THE INVENTION

The present invention provides a family of TCM signaling schemes that change the signal constellation used for transmission periodically. A set of specific embodiments is provided that demonstrate how to improve performance of the known trellis coded 4-PAM signaling schemes such as the one shown in FIG. 1. These disclosed embodiments periodically reduce the 4-PAM signal constellation of FIG. 1 to a 2-PAM signal constellation by combining selected constellation points during selected periodic signaling intervals.

A first aspect of the present invention relates to a transmitter apparatus. The transmitter apparatus uses a convolutional encoder to transform a stream of input bits to a stream of convolutionally-encoded bits. A signal mapper then maps the stream of convolutionally-encoded bits to a periodically-reduced signal constellation. For example, the periodically-reduced signal constellation may comprise a 2-PAM signal constellation in a first periodic signaling interval and a 4-PAM signal constellation in a second periodic signaling interval. Also, the 2-PAM signal constellation may be formed by merging pairs of signal points from the 4-PAM signal constellation and applying an appropriate scaling factor as needed to maximize the normalized minimum distance of the periodically reduced coded scheme.

A second aspect of the present invention also relates to a transmitter apparatus and a related method. This transmitter apparatus also uses a convolutional encoder configured to transform a stream of input bits to a stream of convolutionally-encoded bits. A signal mapper then maps the stream of convolutionally-encoded bits to a coded periodically-reduced 4-PAM/2-PAM signal where a 4-PAM signal point is transmitted in a first periodic signaling interval and a reduced 2-PAM signal point is transmitted in a second periodic signaling interval.

A third aspect of the present invention relates to a receiver and a Viterbi decoder used in the receiver. After signal reception, a Viterbi decoder is used to decode a signal whose signal points are drawn from a periodically-reduced signal constellation. During a first periodic signaling interval L branch metrics are computed and used in Viterbi decoding. During a second periodic signaling interval M branch metrics are computed and are used in Viterbi decoding. Here L and M are integers with M less than L. In a set of currently analyzed 4-PAM/2-PAM type embodiments, M=L/2.

More generally, L constellation points can be used in one periodic interval and M<L can be used in another. For example, a 16-QAM constellation could be used in the first periodic interval and a 12-QAM constellation could be used in another periodic interval by combining a selected number of points. When designing such a scheme, the key is to look at the minimum distance of the overall scheme and select the M-point and L-point constellations.

When such a strategy is employed, the present invention provides transmitter apparatus and related receiver apparatus that use an encoder that encodes a stream of input bits to produce a stream of coded bits, and also a first signal mapper. The first signal mapper maps the stream of coded bits onto a periodically-reduced constellation. The encoder and the first signal mapper produce a coded periodically-reduced signal that has a normalized minimum distance measure that is larger than the maximum value that the normalized minimum distance measure can achieve by using the encoder with a second signal mapper that maps the stream of coded bits, during all signaling intervals, to the largest signal constellation used during any interval by the first signal mapper. The decoder of the coded periodically-reduced signal uses a smaller signal constellation during one or more selected periodic intervals.

### BRIEF DESCRIPTION OF THE FIGURES

The various novel features of the present invention are illustrated in the figures listed below and described in the detailed description that follows.

FIG. 1 illustrates a rate-1/2, four-state data encoder and a signal mapper for use in generating prior art trellis coded 4-PAM.

FIG. 2 illustrates a rate-1/2, four-state data encoder and a signal mapper for use in generating a trellis coded signaling scheme that periodically alternates between 2-PAM and 4-PAM signal constellations.

FIG. 3 illustrates a rate-1/2, eight-state data encoder and a signal mapper for use in generating a trellis coded signaling scheme that periodically alternates between 2-PAM and 4-PAM signal constellations.

FIG. 4 tabulates the properties of the various periodically reduced 2-PAM/4-PAM codes and compares their performance with known Ungerboeck codes as a function of v , which is the number of delay elements needed to generate the corresponding convolutional code.

FIG. 5 shows a transmitter structure (method or apparatus) used to transmit a periodically-reduced signal onto a channel.

FIG. 6 shows a receiver structure (method or apparatus) used receive a periodically-reduced signal and to decode it.

### DETAILED DESCRIPTION OF THE PREFERRED EMBODIMENTS

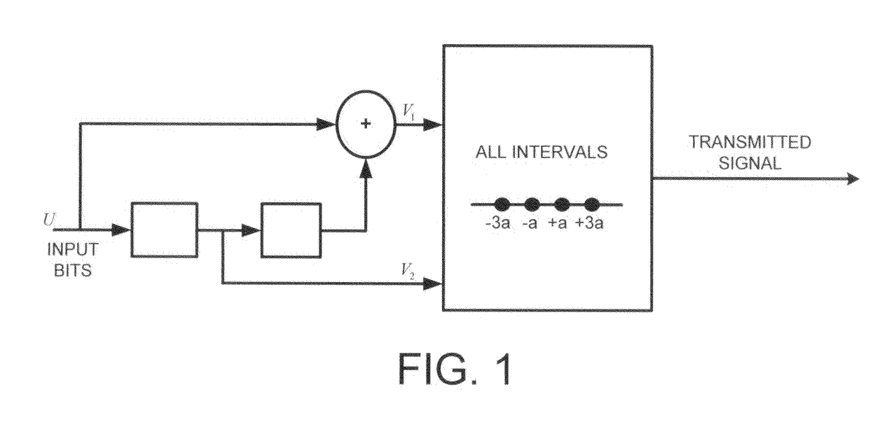

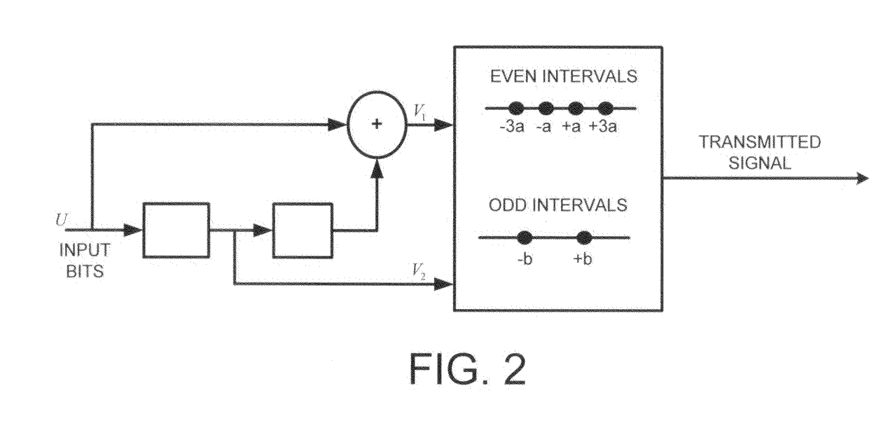

The present invention begins by observing that the mapping policy of the known coded scheme shown in FIG. 1 with the same (5,2) code can be changed to; {00 11 10 01}→{+3a, +a, −a, −3a} without changing the minimum distance. The present invention also observes that with this modified mapping policy, if the constellation is periodically changed between 4-PAM and 2-PAM (2-PAM is also known as BPSK, binary phase shift keying) as shown in FIG. 2, the same raw minimum Euclidean distance of MSED=36a² of the known code can be maintained. The exemplary scheme of FIG. 2 can be viewed as combining coded bit combinations 00 and 11, and 10 and 01, during alternate intervals. Equivalently, the exemplary scheme of FIG. 2 can be viewed as employing the mapping policy {00 11 10 01}→{+3a +a −a −3a} during all even (odd) intervals and employs the mapping policy {00 11 10 01 }→{+b +b −b −b} during all odd (even) intervals.

FIG. 2 shows a specific example of an encoder/mapper portion of a transmitter apparatus. The convolutional encoder is more generally configured to transform a stream of input bits to a stream of convolutionally-encoded bits. A stream is a set of two or more bits, usually in a in a sequence, as in a bit stream. In the embodiment of FIG. 2, a signal mapper is configured to map the stream of convolutionally-encoded bits to a coded periodically-reduced 4-PAM/2-PAM signal where a 4-PAM signal point is transmitted in a first periodic signaling interval and a reduced 2-PAM signal point is transmitted in a second periodic signaling interval. A sub-stream of 4-PAM signal points is transmitted in a set of successive first periodic signaling intervals, and a sub-stream of 2-PAM signal points is transmitted in a set of successive second periodic signaling intervals.

In the example of FIG. 2, the 2-PAM is derived from the 4-PAM by merging pairs of the 4-PAM constellation as discussed above, but also by applying a scale factor to place the 2-PAM points at a desired location on the real axis. For example, it was found that when b=2a, the scheme of FIG. 2 has a raw minimum distance of MSED=36a² and an average energy of E_{avg}=(5a²+b²)/2=4.5a². Recalling that the scheme of FIG. 1 has MSED=36a² and E_{avg}=5a², so that the scheme of FIG. 2 gains 0.46 dB over the known Ungerboeck coded scheme of FIG. 1, and gains 3.01 dB over uncoded BPSK (i.e., uncoded 2-PAM). In this case the scale factor is two (since b=2a) and the scale factor is applied to the 4-PAM points with minimum absolute value.

Other periodically-reduced 4-PAM/2-PAM type embodiments can be designed using other types of codes such as convolutional codes with v=3, 4 and 6 (where v refers to code's memory, i.e., the number of delay elements in the feedback shift register configuration used to generate the corresponding convolutional code). In these embodiments, the constellation can be periodically reduced according to various patterns beside the alternating pattern used in FIG. 2. Also, there is no guarantee that the convolutional codes used in Ungerboeck trellis encoders are optimal when a periodically-reduced mapping rule is applied. Therefore, a joint search should be conducted for different convolutional codes and different constellation-reduction patterns in order to find the best combinations of convolutional (or other types of) codes, periodically-reduction patterns, constellations, and scale factors.

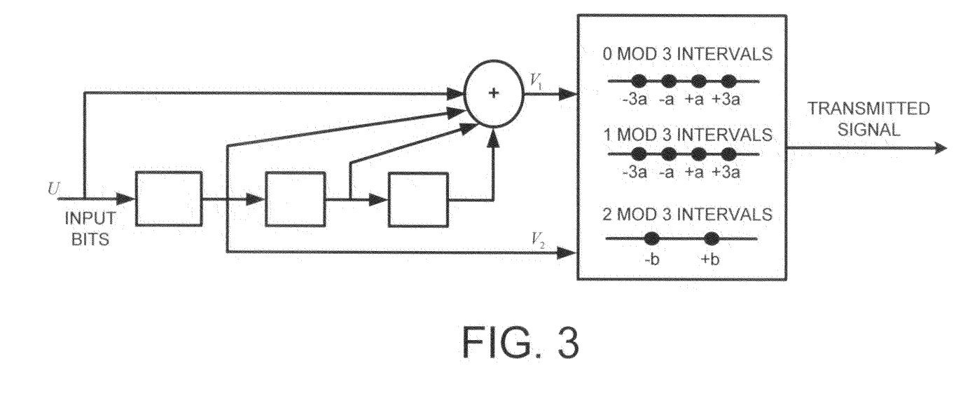

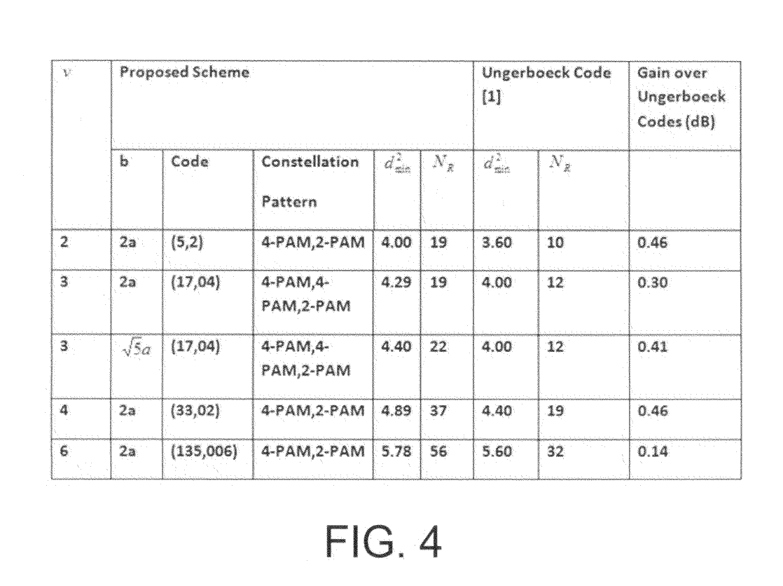

It was numerically found that even at higher values of v, the modified mapping policy; {00 11 10 01}→{+3a, +a, −a, −3a}, performed better with various variations of the 4-PAM/2-PAM scheme of FIG. 2, and this mapping is thus used in all of the specific examples whose performances are tabulated in FIG. 4. When v=3, a search was conducted among different convolutional codes with two different constellation patterns; (a) alternating 4-PAM and 2-PAM, and (b) pattern that transmits 4-PAM, 4-PAM, and 2-PAM with a period of 3. It was found that the (17,04) code (in octal) shown in FIG. 3 with pattern (b) can achieve the same raw minimum distance of Dₘᵢₙ²=40a² as with the Ungerboeck code when b=2a. Hence, the overall average energy of this scheme of FIG. 3 is (5a²+5a²+b²)/3=14a²/3, and the gain over the Ungerboeck code with v=3 is 10*log(5/(14/3))=0.30 dB. The scheme of FIG. 3 has a path memory length of 19 compared with 12 of the prior art v=3 Ungerboeck code that uses 4-PAM in each signaling interval. In FIG. 3, note that numbers divisible by three are “0 mod 3” and numbers whose remainder is one after division by three are “1 mod 3” and numbers whose remainder is two after division by three are “2 mod 3.”

It was also found that with the above scheme with v=3 and the (17,04) code, if the scale factor, b, is increased to b=\sqrt{5a}, the raw minimum distance can be increased to 44a². In this case, there is no reduction in average energy, however, there is an increase in the minimum distance, which corresponds to a gain of 10*log(44/40)=0.41 dB. This scheme has a path memory length of 22.

Similarly, the numerical results for coded periodically-reduced 4-PAM/2-PAM schemes with v=4 and v=6 have been evaluated. FIG. 4 tabulates the properties of the embodiments that were specifically evaluated and compares their performance with the corresponding known Ungerboeck codes as a function of ν. The results tabulated in FIG. 4 indicate that changing the constellation during selected intervals according to a pre-selected pattern can improve the performance of the known trellis coded schemes.

As can be seen from FIG.'s 2-4, the present invention generally provides a transmitter apparatus and method that use a convolutional encoder to transform a stream of input bits to a stream of convolutionally-encoded bits. A signal mapper then maps the stream of convolutionally-encoded bits to a periodically-reduced signal constellation. For example, as shown in FIG. 2 and FIG. 3 and as described by FIG. 4, the periodically-reduced signal constellation can comprise a 4-PAM signal constellation in a first periodic signaling interval and a reduced 2-PAM signal constellation in a second periodic signaling interval. Here “periodic signaling interval” refers to an interval that occurs in a sequence of signaling intervals that periodically repeats. For example, in FIG. 2, there are first and second periodic signaling intervals shown where 4-PAM is sent in the first periodic signaling interval and 2-PAM is sent in the second periodic signaling interval.

In the embodiment of FIG. 2, a sub-stream of 4-PAM symbols is transmitted in even-numbered intervals and a sub-stream of 2-PAM symbols is transmitted in odd-numbered intervals, where the intervals are numbered with respect to a symbol index. In the embodiment of FIG. 3, the periodically-reduced signal constellation comprises a 4-PAM signal constellation in a first periodic signaling interval, the 4-PAM signal constellation in a second periodic signaling interval, and a 2-PAM signal constellation in a third periodic signaling interval. It can be noted that the symbol index can be arbitrarily shifted, so that it is the order of the periodic intervals that is of importance, not the specific even or odd relation (or mod K relation) with respect to the symbol index.

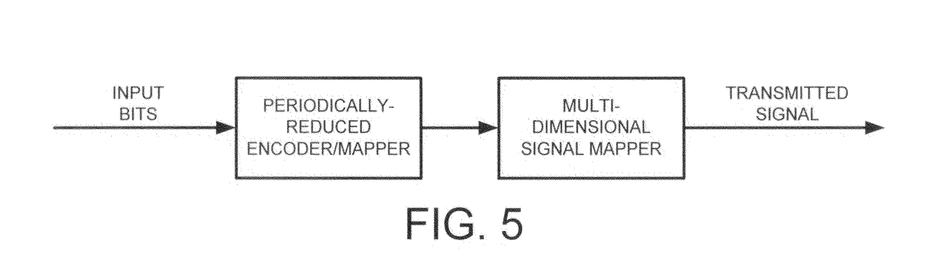

FIG. 5 shows a transmitter structure (method or apparatus) used to transmit a periodically-reduced signal onto a channel. An input bit stream is sent to a periodically-reduced encoder/mapper similar to those described in connections with FIG.'s 2-4. The output of one or more such periodically-reduced encoder/mappers is sent to a multi-dimensional signal mapper. For example, the multidimensional signal mapper can have N=2 dimensions and thus correspond to a QAM transmitter. A sequence of signal points drawn from a periodically-reduced 4-PAM/2-PAM signal constellation can then be transmitted on an in-phase channel of the QAM transmitter. Meanwhile, a second sequence of signal points drawn from the periodically-reduced 4-PAM/2-PAM signal constellation can be transmitted on a quadrature-phase channel of the QAM transmitter. This is one example of how to construct a periodically-reduced signal constellation that comprises a 16-QAM constellation in a first periodic signaling interval and a 4-QAM constellation in a second periodic signaling interval.

Another example of how to generate a periodically-reduced signal constellation that comprises a 16-QAM constellation in a first periodic signaling interval and a 4-QAM constellation in a second periodic signaling interval would be to start with a higher order code such as rate 7/8 code. The rate 7/8 code is used to transmit 4 coded bits in each interval forming a two dimensional, 16-QAM trellis code. This code is then periodically-reduced directly to arrive at 16-QAM/4-QAM scheme. Using the present invention, depending on the particular selected 7/8 code, it is often possible to find a coded periodically-reduced signal that outperforms the 16-QAM constellation. Also, depending on the particularities of the selected rate 7/8 code, a specifically selected combination of a constellation, scale factor, and a periodic-reduction pattern may be found to provide better performance than other choices.

In a different type of embodiment one or more dimensions of the constellation are periodically reduced instead of the constellation size. The reduced dimensions can optionally be reused to send additional information. For example, in one embodiment, two periodically-reduced 4-PAM/2-PAM signals are sent at the same time, one the I channel and the other on the Q channel. During 4-PAM intervals, 16-QAM is sent while in the 2-PAM intervals, a single 4-PAM is sent on the I-channel only. It is noted that the scale factor can cause the 4-PAM sent during the reduced intervals to be higher, thus increasing the average energy of the 4-PAM sent during those intervals. However, since a dimension is reduced every other interval, an additional half-data-rate 4-PAM signal or a half-data-rate periodically-reduced 4-PAM/2-PAM signal can be sent on the Q-channel when the Q-channel would otherwise be unused. If the parameters are chosen correctly, this increase in data rate can compensate for the increase in 4-PAM energy due to the scale factor during the periodic reduction intervals, thus yielding a net improvement in coding gain.

Another issue is the PAPR (peak to average power ratio). If 16-QAM and 4-QAM are alternatively sent each signaling interval, the PAPR we will increase. However, individual coded periodically-reduced 4-PAM/2-PAM signals can more advantageously be sent on the I and Q channels in a staggered way. When the 4-PAM constellation is used on the I-channel, the 2-PAM constellation is used on the Q-channel and vice-versa. This has the net effect of lowering the PAPR. As an alternative, PAPR can also be reduced by sending additional information during intervals where the constellation is reduced. For example, 16-QAM/4-QAM signal can be sent where during the 4-QAM intervals, one or two additional coded bits are sent from a separate sub-stream to increase the data rate. For example, if b=2a and one extra coded bit is sent during each reduced 4-QAM interval, then a 16-QAM/8-QAM signal would result with a very slight increase in PAPR and a possibility for a further increase in coding gain if the codes and the mappings are properly designed via an exhaustive search.

In a multidimensional code of dimension N>2, different multidimensional symbols could also be periodically reduced. For example, consider a 4-dimensional symbol such as a 4D Wei code as discussed in the above-referenced '817 patent. In a 4D Wei code, one 4D symbol is sent during two 2D QAM symbol intervals (one 4D symbol comprises two 2D constituent symbols). Using the principles of the present invention as discussed above, a stream of 4D symbols of a Wei code (or a similar multidimensional code) can be reduced to a stream {4D, 2D, 4D, 2D . . . } or {4D, 4D, 2D, . . . } etc. That is, the present invention can be applied to symbols defined by 1D codes, 2D codes, or higher dimensional codes. Any combination of the above concepts are contemplated be used to develop periodically reduced TCM schemes that reduce either the number of signal points per dimension or reduce the number of constituent symbols that need to be sent in a higher dimensional code.

As indicated above, a periodically-reduced signal constellation can be constructed that sends symbols from an (N+k)-dimensional constellation in a first periodic signaling interval (for example constructed using (N+k)/2 constituent QAM signaling intervals) and a symbols from a N-dimensional constellation in a second periodic signaling interval (for example constructed using N/2 constituent QAM signaling intervals), where N is a first positive integer and k is a second positive integer. In a general sense, this is an example of a “periodically-modified constellation.” That is, the shape of the constellation and any scaling used from interval to interval are allowed to vary periodically, but not necessarily to reduce the size of the constellation. The periodically modified constellation is selected to increase the overall normalized minimum distance of the coded periodically-modified signal over a coded signal that uses the unmodified constellation with the same code.

In a preferred embodiment, a transmitter can generally be constructed using an encoder that encodes a stream of input bits to produce a stream of convolutionally-encoded bits. For example, see the encoder portions of FIG.'s 1-3. In other kinds of embodiments block codes, turbo codes, serial concatenated codes, and the like could be optionally used instead of a convolutional code. A code combiner is then used to select at least two different combinations of coded bits from the stream of encoded bits. At least two different combinations of coded bits are periodically combined by the code combiner. In FIG's 2-3, this is performed by the signal mapper portion. That is, for example, in FIG. 2, a first signal mapper that maps the at least two different combinations of coded bits to respective distinct signal points of a first signal constellation during a first periodic interval, e.g., the 4-PAM interval in FIG. 2. A second signal mapper maps the at least two different combinations of coded bits to a single signal point of a second signal constellation during a second periodic interval, e.g., the 2-PAM interval in FIG. 2. As shown in the example of FIG. 2, the second signal constellation has fewer signal points than the first signal constellation and at least two of the signal points of the second constellation are scaled with respect to respective signal points in the first signal constellation. The second signal constellation is selected such that when stream of convolutionally-encoded bits are mapped periodically to the first and second constellations, a measure of minimum Euclidian distance is increased when compared to a minimum Euclidian distance of the stream of convolutionally-encoded bits when mapped to the first signal constellation. In FIG. 3, it is further shown that a third signal mapper can be optionally added to map coded bits to respective distinct signal points of the during a third periodic interval. More such signal mappers can be added for use in mapping to additional periodic intervals as well.

For any given code such as a convolutional code, the present invention searches for ways to combine coded bits in a periodic manner. There may be multiple ways to combine sets of one or more codewords, and some combination rules will be preferable over others. Once a combination rule is selected, the present invention uses a signal combiner and a signal mapper to map sequences of codewords and codeword combinations onto a periodically-reduced signal constellation. For example, 1-D PAM, 2D QAM, or 4D constellations with two constituent QAM symbols in 2 successive signaling intervals can be used. Depending on the selected number of dimensions, the constellations used for transmission can be scaled by one or more scale factors applied to one or more dimensions to increase the minimum Euclidean distance. Preferably, the one or more scale factors are selected to maximize the minimum Euclidian distance of the resulting periodically-reduced trellis coded modulation system. Once the number of dimensions is selected, an exhaustive search can be performed to optimize the constellation's scaling and to select the best way to combine the coded bits in a periodic manner to maximize the minimum squared Euclidian distance of the overall trellis coded scheme.

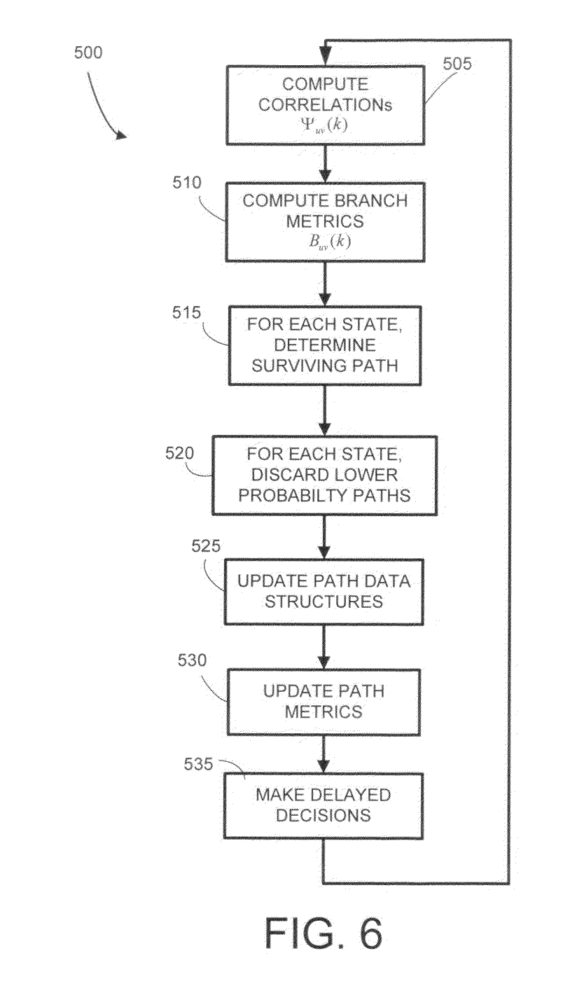

FIG. 6 shows a receiver structure (method or computerized/digital apparatus) used to receive and decode a coded periodically-reduced signal. In a block 505 a signal is received, and optionally demodulated and filtered, and then is optionally signal-conditioned (which preferably includes carrier and/or signal timing recovery). This received and optionally conditioned signal is used to compute a set of correlations relative to a set of possible transition signals out of each of a set of states. At block 510 a set of branch metrics is computed using known Viterbi decoding branch metric calculation techniques. At block 515, for each trellis state, the appropriate branch metric is added to each candidate incoming trellis path metric and a survival path is determined as the path with the lowest path metric. At block 520 all paths that are not survival paths are discarded. At block 530, portions of the path data structure that keep track of the survival paths are updated, and at block 535 the path metrics for the survival paths are updated. At block 535, delayed symbol decisions are made. The symbol decisions are typically delayed by the path memory length of the code being decoded, i.e., when it is known that no competing survivor paths will offer alternative possibilities. Each new signaling or symbol interval, the process repeats.

In order to decode a coded periodically-reduced signal, blocks 505 and 510 periodically change the way they compute their metrics each time the process periodically shifts from a full to a reduced interval. For example, when decoding the signal generated by FIG. 2, block 510 computes four distinct branch metrics during the 4-PAM transmission intervals but only computes two distinct metrics during the 2-PAM intervals. Note this results in a saving, since a decoder designed to decode the transmitted signal of FIG. 1 must compute four distinct branch metrics during all intervals.

In addition, note that if the coded periodically-reduced 4-PAM/2-PAM signal of FIG. 2 is sub-sampled during just the 2-PAM intervals, this sub-sampled signal will have a constant envelope. Hence, these intervals can be easily used to estimate any fading in the channel at the receiver in block 505 and/or to use a constant-modulus equalizer, thus simplifying equalization. Also, symbol timing recovery needed in block 505 can be simplified due to the periodically-varying constellations, for example, by adjusting the sampling moment in order to minimize the energy in a first periodic subinterval and to maximize energy in a second periodic sub-interval, where the starting time or epoch of each sub-interval is fixed relative to the sampling moment. That is, embodiments of the decoder structure of FIG. 6, can be constructed with simplified signal timing recovery and equalization in block 505, all of which can be programmed using digital signal processing computer programming.

Although the present invention has been described with reference to specific embodiments, other embodiments may occur to those skilled in the art without deviating from the intended scope. For example, phase modulation systems such as coded BPSK/QPSK or coded QPSK/8-PSK could be designed using these same basic strategies. All figures showing block diagrams also identify corresponding methods as well as apparatus. All “transmitted signals” shown in the Figures can be applied to various types of systems, such as cable modem channels, digital subscriber line (DSL) channels, individual orthogonal frequency division multiplexed (OFDM) sub-channels, and the like. Systems can be configured whereby a transmitter sends information to a receiver, for example on a wireless OFDM channel used in WiFi and WiMAX systems. Hence it is noted that all such embodiments and variations are contemplated by the present invention.

What we claim is:

1. A transmitter apparatus, comprising:
a convolutional encoder configured to transform a stream of input bits to a stream of convolutionally-encoded bits; and
a signal mapper configured to map the stream of convolutionally-encoded bits to a periodically-reduced signal constellation.

2. The transmitter apparatus of claim 1, wherein the periodically-reduced signal constellation comprises a 4-PAM signal constellation in a first periodic signaling interval and a 2-PAM signal constellation in a second periodic signaling interval.

3. The transmitter apparatus of claim 2, wherein the 2-PAM signal constellation is formed by merging pairs of signal points from the 4-PAM signal constellation, applying a scaling factor, and assigning the respective merged and scaled pairs to respective 2-PAM constellation points.

4. The transmitter apparatus of claim 2, wherein a sub-stream of 4-PAM symbols is transmitted in even-numbered intervals and a sub-stream of 2-PAM symbols is transmitted in odd-numbered intervals, wherein the intervals are numbered with respect to a symbol index.

5. The transmitter apparatus of claim 2, wherein a sequence of signal points drawn from the periodically-reduced signal constellation is transmitted on an in-phase channel of a QAM transmission.

6. The transmitter apparatus of claim 1, wherein the periodically-reduced signal constellation comprises a 4-PAM signal constellation in a first periodic signaling interval, the 4-PAM signal constellation in a second periodic signaling interval, and a 2-PAM signal constellation in a third periodic signaling interval.

7. The transmitter apparatus of claim 1, wherein a sequence of signal points drawn from the periodically-reduced signal constellation is transmitted on an in-phase channel of a QAM transmission.

8. The transmitter apparatus of claim 7, wherein a second a sequence of signal points drawn from the periodically-reduced signal constellation is transmitted on a quadrature-phase channel of the QAM transmission.

9. The transmitter apparatus of claim 1, wherein the periodically-reduced signal constellation comprises a 16-QAM constellation in a first periodic signaling interval and a 4-QAM constellation in a second periodic signaling interval.

10. The transmitter apparatus of claim 1, wherein the periodically-reduced signal constellation comprises a (N+1)-dimensional constellation in a first periodic signaling interval and a N-dimensional constellation in a second periodic signaling interval, where N is a positive integer.

11. The transmitter apparatus of claim 1, wherein the periodically-reduced signal constellation comprises a (N+k)-dimensional constellation in a first periodic signaling interval and a N-dimensional constellation in a second periodic signaling interval, where N is a first positive integer and k is a second positive integer.

12. A transmitter apparatus, comprising:
a convolutional encoder configured to transform a stream of input bits to a stream of convolutionally-encoded bits; and
a signal mapper configured to map the stream of convolutionally-encoded bits to a coded periodically-reduced 4-PAM/2-PAM signal wherein a 4-PAM signal point is transmitted in a first periodic signaling interval and a 2-PAM signal point is transmitted in a second periodic signaling interval.

13. The transmitter apparatus of claim 12, wherein the 4-PAM signal point is drawn from a 4-PAM signal constellation and the 2-PAM signal point is drawn from a 2-PAM signal constellation, and the 2-PAM signal constellation is formed by merging pairs of signal points from the 4-PAM signal constellation and assigning the respective merged pairs to respective 2-PAM constellation points.

14. The transmitter apparatus of claim 12, wherein at least one additional 4-PAM signal point is sent in at least one third periodic signaling interval.

15. The transmitter apparatus of claim 14, wherein the 2-PAM constellation points are derived by multiplying two selected ones of the 4-PAM signal points by a scaling factor.

16. A method for use in a transmitter apparatus, comprising:
convolutionally encoding a stream of input bits to produce a stream of convolutionally-encoded bits; and
mapping the stream of convolutionally-encoded bits to a coded periodic 4-PAM/2-PAM signal wherein a 4-PAM signal point is transmitted in a first periodic signaling interval and a 2-PAM signal point is transmitted in a second periodic signaling interval.

17. The method of claim 16, wherein the 4-PAM signal point is drawn from a 4-PAM signal constellation and the 2-PAM signal point is drawn from a 2-PAM signal constellation, and the 2-PAM signal constellation is formed by merging pairs of signal points from the 4-PAM signal constellation and assigning the respective merged pairs to respective 2-PAM constellation points.

18. The method of claim 16, wherein at least one additional 4-PAM signal point is sent in at least one third periodic signaling interval.

19. A transmitter apparatus comprising:
an encoder that encodes a stream of input bits to produce a stream of coded bits; and
a first signal mapper that maps the stream of coded bits onto a periodically-reduced constellation;
wherein the encoder and the first signal mapper produce a coded periodically-reduced signal that has a normalized minimum distance measure that is larger than the maximum value that the normalized minimum distance can achieve by using the encoder with a second signal mapper that maps the stream of coded bits, during all signaling intervals, to the largest signal constellation used during any interval by the first signal mapper.

20. A transmitter apparatus comprising:
an encoder that encodes a stream of input bits to produce a stream of convolutionally-encoded bits; and
a code combiner that selects at least two different combinations of coded bits from the stream of convolutionally-encoded bits, and periodically associates these at least two different combinations of coded bits;
a first signal mapper that maps the at least two different combinations of coded bits to respective distinct signal points of a first signal constellation during a first periodic interval;
a second signal mapper that maps the at least two different combinations of coded bits to a single signal point of a second signal constellation during a second periodic interval;
wherein the second signal constellation has fewer signal points than the first signal constellation and at least two of the signal points of the second constellation are scaled with respect to respective signal points in the first signal constellation, and the second signal constellation is selected such that when stream of convolutionally-encoded bits are mapped periodically to the first and second constellations, a measure of minimum Euclidian distance is increased when compared to a minimum Euclidian distance of the stream of convolutionally-encoded bits when mapped to the first signal constellation.

21. The transmitter of claim 20, further comprising:
a third signal mapper that maps the at least two different combinations of coded bits to respective distinct signal points of the second signal constellation during a third periodic interval.
